(19) United States
(12) Patent Application Publication
(10) Pub. No.: US 2011/0086790 A1
(43) Pub. Date: Apr. 14, 2011

(54) COMPOSITION INCLUDING ONE OR MORE HYDROLYTICALLY UNSTABLE COMPONENTS

(75) Inventors: ROBERT BARRIE AINSCOW, CHESHIRE (GB); ROBERT VERNON AINSCOW, MANCHESTER (GB); NORMAN CHARLES LOWE, MANCHESTER (GB)

(73) Assignee: CHEMLINK SPECIALITIES LIMITED, MANCHESTER (GB)

(21) Appl. No.: 12/902,833

(22) Filed: Oct. 12, 2010

(30) Foreign Application Priority Data
Oct. 14, 2009 (GB) GB 0917951.6

(51) Int. Cl. C11D 17/00

(52) U.S. Cl. 510/221; 510/231; 510/220; 510/224

(57) ABSTRACT

A composition is provided suitable for use in a cleaning or washing process. The composition includes an activation agent for activating at least one aqueous sensitive component in use. The composition further includes a water soluble builder component and the activation agent is adsorbed onto a surface of the water soluble builder component.

### CROSS-REFERENCE TO RELATED APPLICATIONS

This application claims priority under 35 U.S.C. §119 of application GB 0917951.6 filed Oct. 14, 2009, herein incorporated by reference in its entirety.

### BACKGROUND OF THE INVENTION

This invention relates to a composition including one or more hydrolytically unstable or aqueous sensitive components.

Although the following description refers almost exclusively to a cleaning composition including hydrolytically unstable components and water soluble sachets containing such a cleaning composition for use in dishwashers, it will be appreciated by persons skilled in the art that the composition could be used for any application or which requires a carrier system that includes hydrolytically unstable components, such as in machine wash compositions, industrial and institutional cleaners, cosmetics, agro chemical adjuvants, bleaching agents, pigments, dyestuffs, corrosion inhibitors, lubricants and/or the like. In addition, the present invention is not restricted to compositions contained in water soluble sachets and can include any composition per se including a water sensitive agent or in fact any type of carrier or dispensing device.

In recent years there has been a move in the field of laundry and hard surface cleaning to provide cleaning compositions in pre-defined dosage forms, such as in the form of tablets for use in washing machines. A problem with cleaning compositions in tablet form is that they typically require a user to handle the product in order to place the tablet, for example, in a washing machine. This is undesirable since the tablet can often disintegrate on handling or the active ingredients contained therein may be harmful to the user or act as an irritant.

In order to overcome this problem, the cleaning composition can be contained in a dosed form, such as a water soluble sachet, thereby removing the requirement for a user to directly contact any active ingredient contained in the sachet. The composition can include a liquid, gel or powder and once the sachets come into contact with water during the cleaning process, such as in the washing machine, the outer film forming the sachet dissolves or disintegrates and the cleaning composition is released therefrom.

Liquid or gel products by virtue of their aesthetic appeal, convenience in handling, ease of measurement, and rapidity of dispersion and dissolution compared to granular products have found favour with consumers. However a problem with water soluble sachets, if the cleaning composition contained therein is to be provided in a gel or liquid form, is that some detergent composition products which are compatible with each other in an anhydrous granular product may interact or exhibit instability to storage in liquid formulations and especially in an aqueous environment, resulting in a reduction in storage stability over time compared with a powder formulation. This is a particular problem if the liquid or gel formulation contains significant quantities of water, as such, the gel or liquid contained in the water soluble sachet results in disintegration of the sachet or gassing of the product over a relatively short time period, such that the manufacturer cannot guarantee the quality of the product reaching the end customer.

### SUMMARY OF THE INVENTION

Aqueous or water sensitive components are components which undergo reaction with water or aqueous solutions and commonly included in cleaning systems, such as bleaching agents, bleaching agent activators, enzymes, anticorrosion agents, biocides, dyestuffs, and fragrances.

A bleaching agent is required for many cleaning compositions in order to remove “bleachable” stains, such as tannin found in tea or red wine, and/or to act as an in situ disinfectant. In laundry powders and auto-dishwashing powders for example, bleach is often provided in the form of a persalt, such as Sodium Perborate or Percarbonate, which is often activated in the wash by the addition of a bleach activator, such as Tetra acetyl ethylene diamine. However, if bleach is added to a gel or liquid composition, the water in the composition leads to activation of the bleach, which causes disintegration of the sachet and instability of the gel/liquid composition. Of particular importance are peroxygen bleaches such as perborates, percarbonates, persulphates, perphosphates and persilicates. Bleach activators including Tetra acetyl ethylene diamine and transition metal complexes particularly of Manganese and Cobalt and enzymes selected from the groups Amylases, Proteases and Lipases, may also be incorporated in cleaning compositions to improve soil and stain removal either singly or in combination with other agents for example bleaching compounds.

In an attempt to overcome the abovementioned problems, the applicants have previously produced a composition (EP1682647) which allows an aqueous sensitive component, such as for example bleach, to be provided in a stable manner within an aqueous sensitive device, such as a water soluble sachet. The contents of EP1682647 are incorporated herein by reference. The disclosed composition is suitable for use in a cleaning or washing process and is located in a single compartment of an aqueous sensitive device. The composition includes at least one aqueous sensitive component and a non-aqueous carrier component for stabilising the aqueous sensitive component. The non-aqueous carrier component includes a mineral oil, a gelling agent and an emulsifying agent for emulsifying the mineral oil.

However, a problem associated with the above composition is that in some applications, such as a dishwashing application where the aqueous sensitive component is a peroxygen bleach, the bleaching affect of the aqueous sensitive component is not sufficiently effective on certain stains, such as tannin. It is believed this problem may be as a result of the activator agent for the aqueous sensitive component or bleach, which in one example is Tetra Acetyl Ethylene Diamine (TAED) has only limited solubility in water and needs to come into direct contact with the bleach donor (i.e. Sodium Percarbonate) to be effective. The TAED is thought to become coated by the carrier oil phase and this, in combination with its poor solubility in water, leads to too slow a production of bleach within the cleaning cycle of the dishwasher.

It is therefore an aim of the present invention to provide a composition including one or more hydrolytically unstable components (referred to as aqueous sensitive component hereinafter) which overcomes the abovementioned problems.

It is a further aim of the present invention to provide a composition for location in a dosage system or dispensing device, such as for example an aqueous sensitive device which overcomes the abovementioned problems.

According to a first aspect of the present invention there is provided a composition suitable for use in a cleaning or washing process, said composition including an activation agent for activating at least one aqueous sensitive component in use, characterized in that the composition includes a water soluble builder component and the activation agent is adsorbed onto a surface of the water soluble builder component.

By having the activation agent for an aqueous sensitive component adsorbed onto a water soluble builder component, this allows the activation agent to be carried in a stable manner prior to use (i.e. when in a substantially or totally non-aqueous environment) and will allow rapid release of the same in use (i.e. when contact is made with an aqueous environment or water (i.e. on solubilisation of the builder component). Rapid release of the activation agent will in turn result in rapid activation of the aqueous sensitive component, thereby making any desired effects of using the aqueous sensitive component, more effective in a shorter space of time.

A further advantage of the present invention is that once the activation agent has been totally or substantially released from the builder component in use, the builder can then perform its function as a builder in the composition and can reduce or replace the requirement for other builders, such as phosphates, carbonates, silicates etc to be present in the composition.

### DESCRIPTION OF THE PREFERRED EMBODIMENT

In one embodiment the builder is a layered silicate component.

In an alternative embodiment the builder is sodium tripoly phosphate.

The term “builder” typically refers to any product, agent or material that can bind cations (such as for example, calcium Ca²⁺ or magnesium, Mg²⁺). Builders are often, but not necessarily exclusively, contained in wash solutions to allow water softening.

Preferably the composition includes the at least one aqueous sensitive component which the activation agent is provided to activate.

Preferably the layered silicate component or builder is in the form of a powder or amorphous solid. The activation agent is preferably in a liquid form and is adsorbed onto one or more surfaces of the layered silicate, powder or solid builder. This adsorption preferably takes place during the manufacture process of the composition. The activation agent typically remains inactive or stable until it makes contact with an aqueous agent or water in use.

Preferably the layered silicate component is a layered sodium di-silicate component with the molecular formula (Na₂Si₂O₅) and further preferably is SKS-6®. Yet further preferably the component is SKS-6HD or a grade of SKS-6 or a form of layered sodium di-silicate containing or including a polycarboxylate. The inclusion of a polycarboxylate has the advantage of reducing glass corrosion in dishwasher cleaning applications.

The use of a layered sodium di-silicate or SKS-6 has a number of advantages including its alkalinity, it softens water and the like. Furthermore the SKS-6 or layered sodium di-silicate can act as a builder in the composition, in addition to acting as a carrying agent for the activator agent, thereby removing the requirement for other builders to be present, such as phosphates, which are known to be less environmentally friendly.

In one embodiment the aqueous sensitive component is a bleach or bleach donor, such as for example sodium percarbonate and/or the like.

Preferably the activation agent for the aqueous sensitive component is substantially water soluble and further preferably can include any or any combination of a peroxide or bleach activator, Acetyl Caprolactam (Peractive® LAC), 4-Morpholine Carbonitrile (Peractive® MOR) and/or the like.

Preferably the activation agent will allow activation of the aqueous sensitive component in an aqueous environment at relatively low temperatures, such as for example between 20-40° C.

In one embodiment the activator agent, builder and/or the aqueous sensitive component is encapsulated in the composition.

In one embodiment the composition contains a mineral oil for stabilising the aqueous sensitive component. The water or aqueous sensitive component is preferably substantially homogenised in the mineral oil to provide an inert stabilising carrier system as a continuous phase for the water sensitive component. Further preferably an emulsifying agent is included in the composition in this embodiment for emulsifying the mineral oil. Use of the mineral oil provides all the advantages set out in EP1682647 but the composition of the present invention allow rapid activation of an aqueous sensitive component.

Preferably the builder and activator agent is provided in a ratio between 5:1 to 10:1.

The mineral oil can act as a defoamer in a cleaning or dishwasher application. Alternatively one or more other anti-foaming agents are included in the composition.

Preferably the mineral oil is typically a refined hydrocarbon and in one preferred example is C₂₀-C₂₈ paraffin. In one embodiment, additional oil components can be used with the mineral oil and can include any or any combination of a vegetable oil, an inert organic liquid, such as fatty acid esters, polyalkylene glycols, other mixtures thereof and/or the like.

In one embodiment the composition and/or aqueous sensitive component is or includes one or more enzymes.

In a preferred embodiment the composition is used in a laundry or dishwashing application.

In one embodiment the composition is in the form of a gel or liquid. Further preferably one or more gelling agents are included in the composition. The gelling agent is required to suspend the active ingredients of the composition therein (i.e. the aqueous sensitive agents). It acts to produce a structured liquid/gel which resists separation or sedimentation of particulates for prolonged periods of time.

In one embodiment the composition is in the form of a powder or tablet.

The composition can be contained within one or more compartments of an aqueous sensitive device. The term aqueous sensitive device refers to any device or member which undergoes some level of reactivity with water. Thus for example the device can disintegrate and/or dissolve when brought into contact with an aqueous solution. For example a water-soluble sachet can be formed from any conventional water sensitive film. Examples of possible films are listed in US2002/0077264. In a preferred embodiment the composition is contained within a single compartment of a water soluble sachet.

In an alternative embodiment the composition can be located in any suitable container, sachet, device, bottle and/or the like.

The composition can also include any or any combination of one or more detergent builders, fragrant components, inert fillers, water softeners, detergents, pigments, dyes, optical brighteners, enzymes and/or the like. These components can be provided in any required amount, the mineral oil and/or other oil components preferably making up the total amount of the composition to 100%.

According to a second aspect of the present invention there is provided a method of manufacturing a composition.

Preferably the liquid activation agent is sprayed or introduced as a mist to the layered silicate component and the components are blended together until substantially mixed. The blending process can take place using any suitable blending means.

Preferably the method of manufacture is undertaken at room temperature (i.e. 18-25° C.) and room pressure (approx. 1 bar).

Preferably the layered silicate component or builder is in the form of a free flowing powder.

Preferably the blended silicate or builder and activation agent is mixed with the other components of the composition in a conventional manner.

In one embodiment mixture of the silicate and activation agent in a simple physical blend allowing the liquid activator to be homogenously dispersed into the final composition to give rapid release of the activator on dilution in water.

According to a further aspect of the present invention there is provided an aqueous sensitive device containing a composition.

According to a yet further aspect of the present invention there is provided a dosage system for a composition. The dosage system of this aspect of the invention is a means of providing at least one pre-determined dose or amount of the composition to a user or apparatus for use by a user. Examples of a dosage system include any or any combination of one or more containers, bottles, pump type dispensers, sachets and/or the like.

According to a yet further independent aspect of the present invention there is provided a composition suitable for use in a cleaning or washing process, said composition including an activation agent for activating at least one aqueous sensitive component in use, characterized in that the composition includes a builder component and the activation agent is adsorbed onto a surface of the builder component. Preferably the aqueous sensitive component is bleach and the activation agent is a bleach activating agent.

Examples of the present invention will now be given with reference to the following description.

### Example 1

One example of the composition of the present invention is a composition for use in a dishwashing application. The composition is provided as a non-aqueous gel in a water soluble sachet.

The composition includes a water sensitive component in the form of a bleach or Sodium Percarbonate. Mineral oil is contained in the composition to act as a non-aqueous carrier for the bleach so as to prevent activation of the bleach in the event of it coming into contact with any water or moisture prior to use.

In accordance with the present invention, a liquid activation agent used to activate the bleach is adsorbed onto a layered silicate component in the composition. The liquid activation agent is readily soluble in water and so can increase the speed of activation of the bleach when the water soluble sachet makes contact with water in the wash cycle of the dishwasher. This in turn makes the bleach component more effective and thus increases the cleaning power of the composition.

In one example of the present invention the layered silicate component used in the composition is a sodium di-silicate called SKS-6®, produced by Clariant GmbH. SKS-6® is manufactured using sand and caustic soda that is converted to water glass and is then spray-dried. The powdery amorphous sodium disilicate crystallises to layered silicate and further grinding and compacting steps can then take place if required.

SKS-6® is polymorphic is composed mainly of a delta phase lattice, with small portions of alpha and beta phase lattice structures. Water molecules that come into contact with SKS-6® form a sodium hydrogen disilicate, kanemite, which causes rapid separation of the layered di-silicate structure and thus causing rapid disintegration of the powder. This in turn allows rapid release of a bleach activator that has been adsorbed onto the surface of the SKS-6®.

The preferred form of SKS-6® used in the present invention is SKS-6HD (also produced by Clariant GmbH) which is an agglomerate of SKS-6 and an acid co-polymer. The SKS-6HD has a particle size of 450-700 μm and has reduced alkalinity compared to other SKS-6 components and so is suitable for fine-fabric detergents used in laundry applications.

The layered silicate used in the present invention, such as SKS-6®, typically softens water by exchanging its sodium ions for the hardness forming ions, calcium and magnesium found in tap water, thereby increasing the cleaning power of the same. Furthermore, SKS-6® has been found to be compatible with a number of different bleach systems.

In one example of the present invention the activation agent or bleach activator is a liquid bleach activator called Peractive® LAC (manufactured by Clariant GmbH). This is a peracetic acid precursor and is substantially more reactive and has increased biodegradability compared to other bleach activators.

In one example of the present invention the bleach activator is a liquid bleach activator called Peractive® MOR (manufactured by Clariant GmbH). This is a 4-Morpholine carbonitrile. It is optimal at activating bleach at relatively low temperatures (i.e. between 20-40° C.) and at an alkalinity of between pH 8-11.

### Example Formulation 1

| Ingredient | % |
|---|---|
| SKS-6HD | 20.0 |
| Peractive LAC | 1.3 |
| Peractive MOR | 1.3 |
| Sodium Carbonate | 5.0 |
| Alcosperse 747D | 2.0 |
| Emulsogen LP | 5.0 |
| Silvergel 5000 | 10.0 |
| Sodium Percarbonate | 12.0 |
| Mineral oil | to 100 |

The bleach activators (Peractive LAC and Peractive MOR) are pre-blended with the builder SKS-6HD in a first container. In a second container the mineral oil, Silvergel and Emulsogen LP are blended together and heated to approximately 100° C. The components in the second container are then allowed to cool and, when cooled to approximately 75° C., the blend in the first container is added to the blend in the second container. The mixture is allowed to cool and is stirred until approximately reaching 60° C., where after the Alcosperse 747 is added. The mixture is allowed to continue to cool to approximately 50° C., wherein the sodium percarbonate and enzyme are added into the mixture.

### Example Formulation 2

| Ingredient | % |
|---|---|
| SKS-6HD/Activator blend | 30.0 |
| Peractive LAC | 2.0 |
| Peractive MOR | 2.0 |
| Sodium Carbonate | 5.0 |
| Alcosperse 747D | 2.0 |
| Emulsogen LP | 5.0 |
| Silvergel 5000 | 10.0 |
| Sodium Percarbonate | 15.0 |
| Purafect OX4000E | 0.5 |
| Mineral oil | to 100 |

The components in formulation 2 are mixed in a similar manner to that described for formulation 1. It will be appreciated that the present invention is not limited to the order of method steps provided in this detailed description.

1. A composition suitable for use in a cleaning or washing process,
said composition including an activation agent for activating at least one aqueous sensitive component in use,
characterized in that the composition includes a water soluble builder component and the activation agent is adsorbed onto a surface of the water soluble builder component.

2. A composition according to claim 1 characterized in that the builder component is a layered silicate component.

3. A composition according to claim 1 characterized in that the builder component is sodium tripoly phosphate.

4. A composition according to claim 2 characterized in that the layered silicate component is in the form of a powder or amorphous solid.

5. A composition according to claim 1 characterized in that activation agent is in liquid form and is adsorbed onto the surface of the builder component.

6. A composition according to claim 2 characterized in that the layered silicate component is a layered sodium di-silicate component, is SKS-6HD® or a grade of SKS-6 or layered sodium di-silicate that contains or includes polycarboxylate.

7. A composition according to claim 1 characterized in that the aqueous sensitive component is a bleach or bleach donor and the activator agent includes any or any combination of a bleach or peroxide activator, Acetyl Caprolactam or 4-Morpholine Carbonitrile.

8. A composition according to claim 1 characterized in that the composition is in the form of a liquid or gel.

9. A composition according to claim 1 characterized in that the activator agent, builder and/or the aqueous sensitive component is encapsulated in the composition.

10. A composition according to claim 1 characterized in that the composition contains a mineral oil.

11. A composition according to claim 10 characterized in that the composition contains an emulsifying agent for emulsifying the mineral oil.

12. A composition according to claim 1 characterized in that the builder component and activator agent are provided in a ratio between 5:1 and 10:1.

13. A composition according to claim 1 characterized in that it includes any or any combination of one or more anti-foaming agents, vegetable oil, inert organic oil, one or more enzymes, one or more gelling agents, detergent builders, fragrant component, inert filler, water softener, detergent, pigment, dye or optical brightener.

14. A composition according to claim 1 characterized in that the composition is contained within one or more components of an aqueous sensitive device.

15. A method of manufacturing a composition suitable for use in a cleaning or washing process,
said composition including an activation agent for activating at least one aqueous sensitive component in use,
characterized in that the method includes the step of adsorbing an activation agent onto a surface of a water soluble builder component.
